(19) United States
(12) Patent Application Publication
(10) Pub. No.: US 2008/0184165 A1
(43) Pub. Date: Jul. 31, 2008

(54) System and Method For Evaluating Content on the Internet Network and Computer Readable Medium Processing the Method

(75) Inventor: Jhung Soo Hong, Paju-Si (KR)

Correspondence Address: RABIN & Berdo, PC, 1101 14TH STREET, NW, SUITE 500, WASHINGTON, DC, 20005, US

(73) Assignee: SK COMMUNICATIONS CORP., Seoul (KR)

(21) Appl. No.: 11/911,524

(22) PCT Filed: Apr. 14, 2006
(86) PCT No.: PCT/KR06/01395

§ 371 Date: Oct. 12, 2007

(30) Foreign Application Priority Data
Apr. 14, 2005 (KR) 10-2005-0031126

(51) Int. Cl. G06F 3/048; G06F 7/10; G06F 17/30

(52) U.S. Cl. 715/810; 707/10; 707/9; 707/5; 707/E17.111

(57) ABSTRACT

Disclosed is a system for evaluating contents in an Internet network, including a user terminal for accessing contents information registered in real time and provided through a web page and performing evaluation on the contents information; and a value analysis server for calculating hubness of each evaluator according to an evaluation order of the contents information and calculating authority of the evaluated contents information based on hubness of each evaluator.

### TECHNICAL FIELD

This invention relates to a method for evaluating contents on an Internet network, and more particularly, to a system and method for evaluating contents on an Internet network and a computer readable medium processing the method.

### BACKGROUND ART

In general, when a user makes a search for a web page in a web site or the like, whether a found web page is good or bad depends on subjective judgment of the user. That is, since the evaluation on quality of a search result is extremely subjective, there is a need of an objective standard excluding a human's subjective judgment in judging a relation of the search result with a search word. Further, there is a need for a formularized method of implementing search quality with an algorithm.

As is generally known, web pages have a number of links interconnecting enormous information on web. Analyzing and evaluating interrelation among the links are meaningful in judging value of the information.

Provision of information on Internet is promoting bidirectional interaction, which is one of attributes of Internet, beyond simple information provision from such as existing newspapers and magazines. That is, the provision of information on Internet is promoting interaction among users as well as interaction between contents and users. Accordingly, users who access the Internet obtain desired information from news or articles on web and seek for various methods, such as replies and recommendations, to meet a desire for communication among the users. Moreover, interest in communication among users with value judgment intervened is increasing.

That is, as news reading on Internet is popularized, there is a need for a public opinion forming structure different from those in existing printed media. This need is now satisfied by methods such as replies.

In case of conventional newspapers, readers are satisfied when their own viewpoints are exhibited on the newspapers, and a desire for communication among readers is little because they read and share the same text. On the other hand, as Internet news is widely spreading, readers read different contents of articles, and therefore, there may be a need of discussion spaces for different opinion groups.

In addition, in the existing newspapers, public opinions are one-sidedly formed based on common experiences and topics for discussion, led by printed media, competing with different public opinions. However, the spreading Internet news transfigures existing public opinion processes and requires alternatives to the transfigured public opinion processes. Accordingly, there is a need of a structure for supporting a new type of public opinion formation through additional communication services.

On the other hand, as methods of forming public opinions on Internet, various methods of registering and recommending or not recommending replies to news or articles have been proposed. However, recommendation for the replies, which is considered a basic communication method, is inactive, and there arises a problem of side effects of the replies due to rampant imprudent spam advertisements and curses.

For example, there are cyber spaces of bulletin boards, such as ‘my comments,’ attached to news made by a pressman, on which relevant opinions are presented as replies. However, due to lack of means for supporting convergence and spread of public opinions as well as lack of a filter against spam, offending replies and the like, exhibitions of public opinions may be one-sidedly conducted. The reason for this is that an Internet space is an anonymous space where there is not much mutual respect and confidence that are the essence of discussion and there are many disposable or volatile exhibitions of opinions. Accordingly, there is a need for construction and reputation management of news media for providing recognition of other parties and possibility of re-meeting, which are essential conditions for mutual confidence, while keeping the anonymity.

In the mean time, portal sites and the like provide separate cyber spaces that do not belong to articles and include discussion bulletin boards and public opinions, allowing users to exchange their opinions. In this case, when a particular article is attracted and issued, it is chosen as the subject of discussion, thus arousing an active opinion exchange. However, the separate cyber discussion spaces have very low participation as compared to replies related to the article. In addition, there arises a problem in that it is difficult to keep order of discussion in the absence of arbitrators and managers of discussion. The reason for this is that activities and evaluations for issues in discussion spaces disappear without being stored. Accordingly, there is also a need for activity management and reputation management to allow discussion arbitrators and managers to execute as proxies.

### DISCLOSURE OF INVENTION

### Technical Problem

It is therefore an object of the present invention to provide a system and method for evaluating contents on an Internet network, which is capable of evaluating importance of an object according to priorities of upper level links connected to a particular lower level link on an Internet web site that provides news information, and providing information produced as a result of the evaluation to users, and a computer readable medium processing the method.

It is another object of the present invention to provide a system and method for evaluating contents on an Internet network, which is capable of efficiently and lastingly evaluating information on a new object updated in real time according to a dynamic evaluation method, and a computer readable medium processing the method.

It is still another object of the present invention to provide a system and method for evaluating contents on an Internet network, which is capable of evaluating authority for each article on Internet, with evaluation of a user reflected on the authority, and allowing the user to obtain hubness to have an effect on edition, and a computer readable medium processing the method.

It is still another object of the present invention to provide a system and method for evaluating contents on an Internet network, which is capable of establishing a communication network by allowing users to obtain authority and hubness through evaluation of users on articles on Internet, and a computer readable medium processing the method.

### Technical Solution

To achieve the above objects, according to an aspect, the present invention provides a system for evaluating contents in an Internet network, including a user terminal for accessing contents information registered in real time and provided through a web page and performing evaluation on the contents information; and a value analysis server for calculating hubness of each evaluator according to an evaluation order of the contents information and calculating authority of the evaluated contents information based on hubness of each evaluator.

Preferably, the contents information is news articles or replies to news articles. Preferably, the evaluation information is reply information or recommendation information.

Preferably, disclosure of the contents information is adjusted according to authority calculated for the contents.

Preferably, the system provides an editor menu for each user, which is reconstructed according to hubness calculated for each evaluator.

Preferably, the value analysis server includes a news article information database including various kinds of information constituting the contents information; a reply recommendation information database including evaluation information on the evaluators; and a link information database including various kinds of link information for the contents information evaluation.

To achieve the above objects, according to another aspect, the present invention provides a method for evaluating contents in an Internet network, including the steps of, by a contents provider, registering new contents information as a web page in a web site; providing the registered contents information to each user in the form of a web page through the web site; by a user, searching and reading the contents through a computer terminal and registering evaluation information on the contents in the web site; and calculating hubness of each evaluator according to an evaluation order of the registered evaluation information and calculating authority of the evaluated contents based on hubness of each evaluator.

Preferably, the contents information is news articles or replies to news articles. Preferably, the evaluation information is reply information or recommendation information.

Preferably, disclosure of the contents information is adjusted according to authority calculated for the contents.

Preferably, the method further includes the step of providing an editor menu for each user, which is reconstructed according to hubness calculated for each evaluator.

Preferably, the value analysis server includes a news article information database including various kinds of information constituting the contents information; a reply recommendation information database including evaluation information on the evaluators; and a link information database including various kinds of link information for the contents information evaluation.

Value analysis information according to the evaluation on contents in the Internet network may be stored in a server computer readable record medium. The record medium includes all kinds of record medium in which programs and data are stored so that they can be read by a computer system. For example, the record medium may include a ROM (Read Only Memory), a RAM (Random Access Memory), a CD (Compact Disk), a DVD (Digital Video Disk)-ROM, a magnetic tape, a floppy disk, an optical data storage, etc., and may be implemented with the form of carrier waves (for example, transmission through the Internet). In addition, the record medium may be distributed in computer systems interconnected by a network so that computer readable codes can be stored and executed in a distributed processing system.

The present invention suggests a method for evaluating contents on an Internet network, which is capable of efficiently and lastingly evaluating information on a new object updated in real time, such as new information on Internet, according to a dynamic evaluation method. To this end, unlike conventional link analysis methods for simply determining an overall order for the whole webs, a new link analysis method for granting different weights to objects according to a link generation order is suggested.

The present invention has the same application to all contents, replies to the contents and the like on the Internet network. In the following description, among the contents, new articles and replies to the news articles will be illustrated by way of example in order to assist in understanding the present invention. Therefore, in the following description, the news articles are to be understood to represent all contents on the Internet network. Especially, the present invention is effective for application to new contents updated in real time and is more suitable for contents such as news articles.

### ADVANTAGEOUS EFFECTS

According to the present invention, it is possible to provide an efficient and dynamic evaluation method by granting a high evaluation index to an evaluation subject or object according to replies to Internet news articles, a recommendation order to Internet contents, or a recommendation order to the replies.

In addition, it is possible to provide a reedition function based on importance of contents and an individual editor function based on analysis on an evaluation index acquired by an evaluation subject, using a result of evaluation according to the evaluation method. Further, it is possible to provide new value information processed in a new network established based on a link relation among evaluation subjects and objects for contents evaluation.

### DESCRIPTION OF DRAWINGS

FIG. 1 is a view illustrating a network structure in which news article links interconnect individuals according to an embodiment of the present invention;

FIG. 2 is a view illustrating concept of a filtering operation utilizing a news network according to an embodiment of the present invention;

FIG. 3 is a view illustrating concept of a casting operation utilizing a news network according to an embodiment of the present invention;

FIG. 4 is a view illustrating concept of a news rank analysis method based on a link relation according to an embodiment of the present invention;

FIG. 5 is a view illustrating a hubness calculating method according to an embodiment of the present invention;

FIG. 6 is a view illustrating an authority calculating method according to an embodiment of the present invention;

FIG. 7 is a view illustrating a structure of a value analysis system based on evaluation on news articles in an Internet network according to an embodiment of the present invention;

FIG. 8 is a view illustrating data fields of a news article information database according to an embodiment of the present invention;

FIG. 9 is a view illustrating data fields of a reply recommendation information database according to an embodiment of the present invention;

FIG. 10 is a view illustrating data fields of a link information database according to an embodiment of the present invention;

FIG. 11 is a flow chart illustrating a value analysis procedure based on evaluation on news articles in an Internet network according to an embodiment of the present invention;

FIG. 12 is a flow chart illustrating an evaluation procedure for articles and replies according to an embodiment of the present invention;

FIG. 13 is a view illustrating a method of providing a comprehensive viewpoint for each news importance according to an embodiment of the present invention;

FIG. 14 is a view illustrating an individual user interface related to a news network according to an embodiment of the present invention;

FIG. 15 is a view illustrating an evaluation method for articles according to an embodiment of the present invention;

FIG. 16 is a view illustrating an inter-user communication method according to an embodiment of the present invention; and

FIG. 17 is a view illustrating an evaluation method for replies to articles according to an embodiment of the present invention.

### MODE FOR INVENTION

Hereinafter, preferred embodiments of the present invention will be described in detail with reference to the accompanying drawings. In the following detailed description of the present invention, concrete description on related functions or constructions will be omitted if it is deemed that the functions and/or constructions may unnecessarily obscure the gist of the present invention.

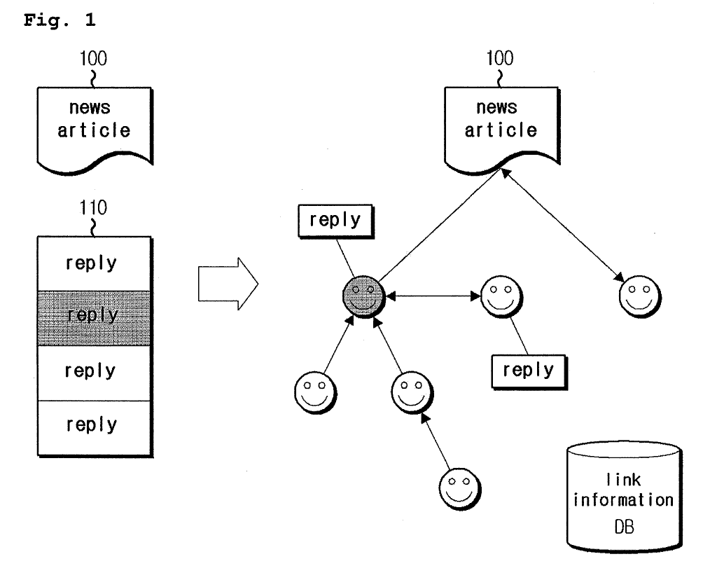

First, concept of the present invention will be described with reference to FIGS. 1 to 3.

As mentioned earlier, problems of replies to articles on Internet derive from a structure of an anonymous and disposable bulletin board where a user has no recognition of other parties and recognition of the user by other parties is also of little importance.

FIG. 1 is a view illustrating a network structure in which news article links interconnect individuals according to an embodiment of the present invention. Referring to FIG. 1, replies to existing news articles are sequentially registered according to an order of reply of repliers, irrespective of interrelation of replies and their importance and without evaluation on the replies, or with only scrappy evaluation, if any. However, in the present invention, information on interrelation of replies (i.e., information on link) and information on recommendation of replies are stored, reliability of information is increased using the stored information, and reliability of evaluation subject or object for the information is increased based on an evaluation index which is described later.

By doing so, effective on-line public opinion formation environments can be provided, which ensure recognition of other parties and persistency of relationship, which are basic conditions of mutual confidence and respect required for improvement of on-line discussion level and collections of public opinions.

In the mean time, in news communication in which public opinions are formed according to response of users to news articles on Internet, a network relation formed among users may be divided into a relation naturally occurring by the use of services and a relation intentionally set by users. In this case, news article information provides new issues lastingly to the users to provide lasting excitement to them, which is fit to arouse response of the users, and, when the naturally occurring relation becomes deepened, intentional relation among the users may be revealed.

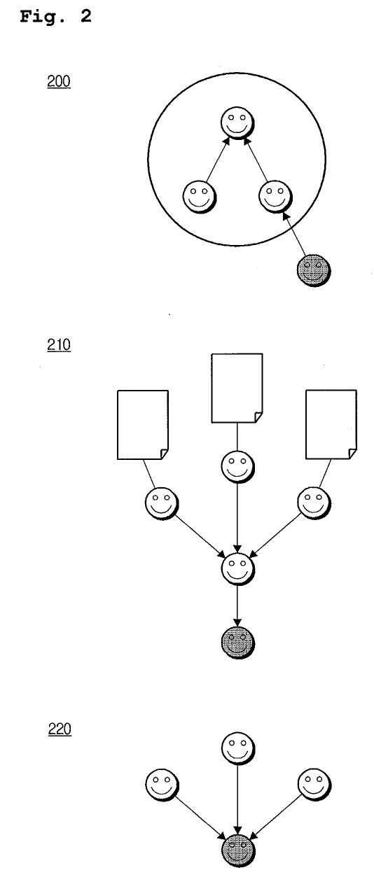

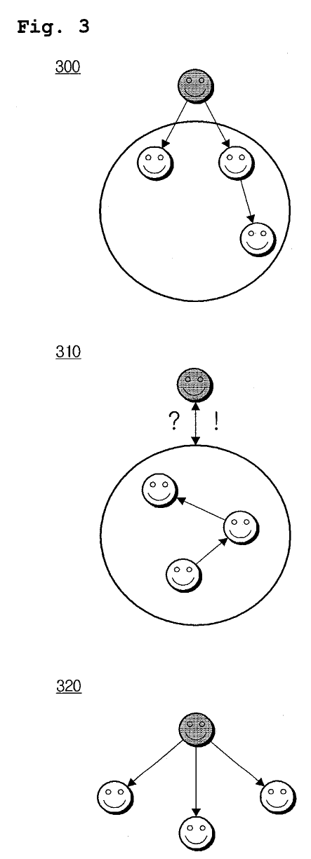

FIGS. 2 and 3 are views illustrating concept of a filtering operation and a casting operation, which are main functions and are implemented by utilizing the news network according to an embodiment of the present invention.

FIG. 2 is a view illustrating concept of the filtering operation utilizing the news network according to an embodiment of the present invention. Referring to FIG. 2, first, an evaluation subject (for example, an individual user) on Internet sees news frequently seen by other users having the same taste (200). At this time, a particular user who is excellent in searching information may acquire a variety of information (210). Here, who is a user having excellent information search ability depends on an evaluation index (i.e., hubness and authority) given to him based on information evaluation suggested in the present invention. Accordingly, a user referred to by many other users can play a role as a hub (220).

FIG. 3 is a view illustrating concept of the casting operation utilizing the news network according to an embodiment of the present invention. Referring to FIG. 3, a particular user can perform various functions including transmission of relevant opinions and information to other users who support the particular user, setting of a topic for discussion, delivery of articles of interest, delivery of contents made or discovered by himself, collection of network user opinions related to a particular issue, etc., through link relation setup according to the present invention (300). In addition, when a particular user asks a particular network a question and receives an answer to the question therefrom, he may inquire of other users who read the same article about contents of the article (310).

Accordingly, a user who can deliver his opinion to many other users may have higher authority, which will be described later (320).

Hereinafter, a news rank evaluation method for evaluating information value based on the link relation setup according to the present invention will be described. First, for the sake of assisting in understanding the news rank evaluation method according to the present invention, a ‘Kleinberg's Algorithm’, being used as one of general link analysis methods, will be described. This method defines authority and hubness and analyzes links based on the defined authority and hubness.

For more detailed explanation, it is assumed that node 2, node 3 and node 4 link to node 1 simultaneously. In this case, linked node 1 becomes a lower node and the linking nodes 2, 3 and 4 become an upper node. Here, it can be seen that the more upper nodes linking to a particular lower node (for example, node 1), the higher importance level it becomes very likely to have.

In analyzing the links, the importance level of the lower node may be expressed by the ‘authority’, and the authority of the lower node may be decided with the number of upper nodes linking to the lower node and an importance information link level of the upper nodes. Here, when the importance information link level of the upper nodes is defined as ‘hubness of the upper nodes, the authority of node 1 may be expressed by the sum of hubnesses of the upper nodes. That is, the authority of node 1 may be expressed as the following Equation 1.

a(1)=h(2)+h(3)+h(4) [Equation 1]

where, a(1) represents authority of node 1 and h( ) represents hubnesses of nodes 2, 3 and 4. In generalization, authority may be calculated according to an iterative algorithm expressed by the following equation 2.

### [Equation 2]

$$a ( v ) 0 {Q}_{wHuppernode [ v ]} h ( w ) \qquad [ Equation 2 ]$$

As another example, it may be assumed that node 1 links to node 5, node 6 and node 7. In this case, the linking node 1 becomes an upper node and the linked nodes 5, 6 and 7 become a lower node.

In this case, a node linking to nodes with high authority related to a subject is referred to as a hub in the sense that it plays a role of a central axis. As mentioned above, when the importance information link level of the hub is defined as ‘hubness, hubness of node 1 may be expressed by the sum of hubnesses of the lower nodes. That is, the authority of node 1 may be expressed as the following Equation 3.

h(1)=a(2)+a(3)+a(4) [Equation 3]

This equation may be generalized as the following equation 4.

### [Equation 4]

$$h ( v ) 0 {Q}_{wHlowernode [ v ]} a ( w ) \qquad [ Equation 4 ]$$

According to the above-described Kleinberg link analysis method, it can be seen that nodes with high authority are linked by many hubs. The more hub a node is linked by, the higher authority the node has. In addition, the more nodes having high authority a node links to, the higher hubness it has. This shows that hubness and authority have a mutually reinforcing relationship.

Accordingly, nodes with high authority may be obtained when nodes (i.e., hubs) with high hubness are found, and the nodes with high hubness may be found through the nodes with high authority. In general search websites, web pages with high hubness and high authority may be considered to be especially good web pages among search results for a global query.

However, since the Kleinberg link analysis method calculates authority and hubness of nodes by accumulating and filtering data on the nodes, as described above, it has a problem of impossibility of accurate evaluation on new contents (i.e., nodes or information). For example, when the Kleinberg link analysis method is applied to a vast amount of new information that web sites produce in real time every day, it is nearly impossible to perform an iterative operation for the new information through data accumulation.

Accordingly, still with authority and hubness used the Kleinberg link analysis method, the present invention defines and uses a new calculation method to allow authority and hubness to be applied to objects requiring a real-time evaluation, such as information on news articles.

For example, when real-time linking and evaluation are performed for particular news and replies, if a particular node has a high rank at which the node links to an object with high importance, high hubness is granted to the node. This allows the object to be efficiently evaluated in real time.

In this time, higher hubness provides nodes with higher discrimination capability for good objects (for example, articles or replies). In addition, when a node is linked by many nodes with high hubness, it has high authority and is then evaluated to be a good object.

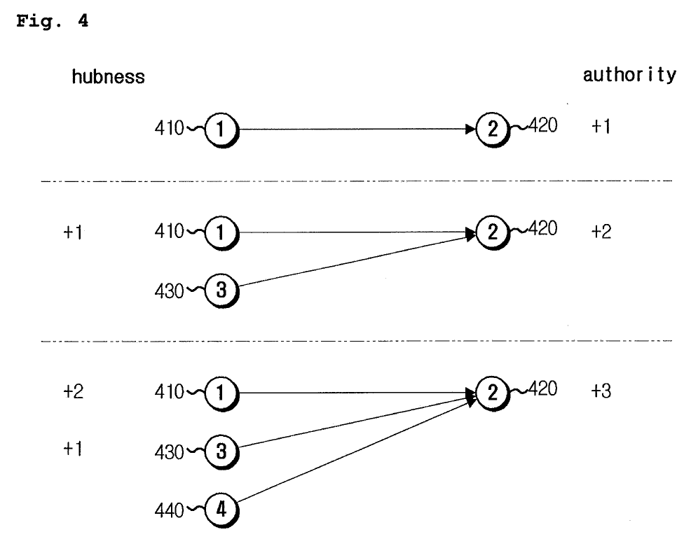

FIG. 4 is a view illustrating concept of a news rank analysis method based on a link relation according to an embodiment of the present invention.

In the present invention, whenever an upper node is additionally linked to a lower node, upper nodes that have been previously linked are calculated again. According to this, authority of the lower node is calculated again. Accordingly, an object to be evaluated is added in real time, and it becomes possible to efficiently evaluate the object according to a relation among links in an information network requiring real time evaluation on the object.

Referring to FIG. 4, first, node 1 410 links to node 2 420, then, node 3 430 links to node 2 420, and lastly, node 4 440 links to node 2 420. Of course, it is obvious that other nodes can link to node 2 420 subsequently.

In this embodiment, when node 1 410 first links to node 2 420, node 1 410 has hubness of 0 or hubness that has been previously acquired, according to a predetermined implementation method. It is assumed in the following description that hubness of the first linked upper node is 0.

Then, when node 3 420 links to the same node, i.e., node 2 420, hubness of node 1 410 that first links to node 2 420 increases by 1. At this time, hubness of node 3 420 for node 2 420 becomes 0.

Next, when node 4 420 links to node 2 420, hubness of all of the previously linked upper nodes (i.e., node 1 410 and node 3 430) increase by 1. Accordingly, hubness of node 1 410 becomes 2, hubness of node 3 430 becomes 1, and hubness of node 4 440 becomes 0.

On the other hand, if previously acquired hubness of a particular upper node is applied to the particular upper node and when upper nodes continue to be added to the same lower node, hubness of the upper nodes additionally linked to the same lower node continues to be added to hubness of an upper node first linked according to the above-mentioned method.

For example, in FIG. 4, assuming that hubness of node 1 410 is 3.2, hubness of node 3 430 is 4.1, and hubness of node 4 440 is 1.5, hubness of node 1 410 is 3.2 with no change when node 1 410 first links to node 2 420. Then, when node 3 430 additionally links to node 2 420, hubness of node 1 410 becomes 7.3 (=3.2+4.1) by adding hubness of node 3 430. Similarly, when node 4 440 additionally links to node 2 420, hubness of node 1 410 becomes 8.8 (=3.2+4.1+1.5) by adding hubness of node 3 430 and hubness of node 4 440. In addition, hubness of node 3 330 becomes 5.6 (=4.1+1.5) by adding node 4 440 linked next.

According to both of the two above-described methods, an upper node that links to the same lower node earlier has higher hubness. In addition, as the number of upper nodes that link to the same lower node later than a particular upper node increases, hubness of the particular upper node continues to increase.

This may be expressed by the following Equations 5 and 6.

H(1)0H(1)+H(3)+H(4) [Equation 5]

H(3)OH(3)+H(4) [Equation 6]

That is, the earlier an upper node links to the same lower node, the higher hubness the upper node has. In addition, as the number of upper nodes that link to the same lower node subsequently increases, hubness of an upper node that links to the same upper node earlier continues to increase.

On the other hand, authority of a lower node is calculated as the sum of hubness of upper nodes that link to the lower node as in the conventional methods. Accordingly, authority of node 2 may be obtained as the sum of upper nodes (that is, node 1 410, node 3 430 and node 4 440) that link to node 2. This may be expressed by the following Equation 7.

A(2)=H(1)+H(3)+H(4) [Equation 7]

In Equation 7, A( ) represents authority of a node and Ho represents hubness of the node as described above.

Accordingly, as authority of a lower node becomes high, evaluation on an object become high. For example, if the lower node is news, when the news is recommended by good hubs (that is, upper nodes), the news becomes a good news. That is, a lower node that is more frequently linked by upper nodes with high hubness has higher authority, with the lower node (for example, news) evaluated as better news.

On the other hand, unlike the conventional methods, since hubness of upper nodes is not calculated by authority of a lower node, but is determined according to an order at which the upper nodes link to the same lower node, a complex iterative operation for finding a convergence value in calculating hubness and authority as in the conventional methods is not required. In addition, whenever a plurality of upper nodes link to a newly generated lower node, hubness and authority of the plurality of upper nodes and the new lower node can be easily calculated.

For example, assuming that the lower node is a newly registered news and links of the upper nodes are replies or recommendations to the news, a user who first recommends a good article has the highest hubness. In addition, when an article receives more replies or recommendations from users who have high hubness, the article has higher authority.

In this way, when the link analysis method of the present invention is applied to a news system, hubness means evaluation capability for good news articles, and, when an article recommended by a particular user receives more recommendations from other users later, the particular user who first recommended the article has capability as a better hub. That is, a hub that first recommends a good article has highest hubness.

In addition, authority means capability to produce good news, and, when news receives more recommendations from users who have high hubness, the news has higher authority.

Similarly, in addition to evaluation on the news, this may be true of evaluation on replies to the news. That is, when news has more good replies that recommend a particular reply, the news has higher authority.

However, the conventional link analysis methods may be suitable for decision of a global order for the overall webs, but not suitable for a single entity such as the new information. Accordingly, it can be said that a dynamic evaluation system as the link analysis method of the present invention is effective for new communications.

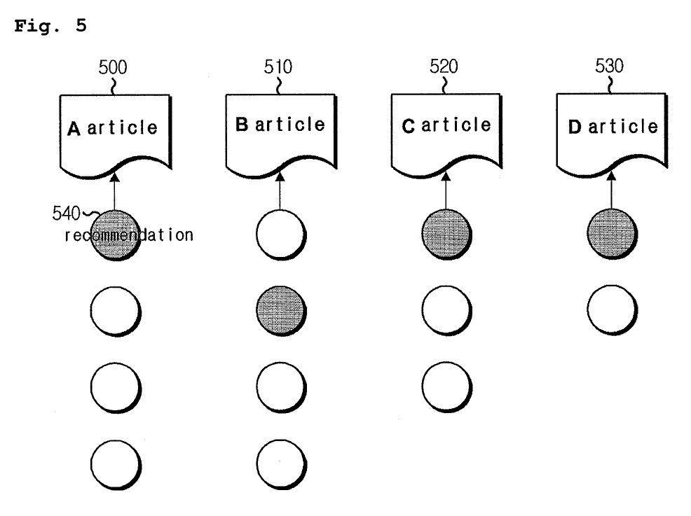

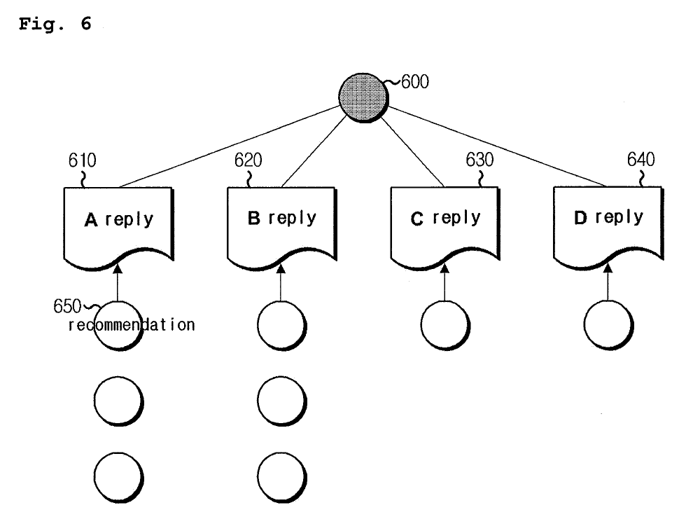

Hereinafter, a preferred embodiment to which hubness and authority calculated according to the present invention are applied will be described with reference to FIGS. 5 and 6.

FIG. 5 is a view illustrating a hubness calculating method according to an embodiment of the present invention.

Referring to FIG. 5, in calculating hubness according to the present invention as described above, different weights may be given to hubness according to a link generation order as well as a static link structure.

For example, as shown in FIG. 5, assuming that a particular user links to an A news article 500 first, a B article 510 second, and C and D articles 520 and 530 first through a recommendation or reply, hubness depends on the number of later links to the articles, according to the above-described method of the present invention.

For example, a particular user (depicted in a shade) has hubness of 3 for the A article 500 since the number of later links to the A article 500 is 3, hubness of 2 for each of the B and C articles 510 and 520 since the number of later links to each of the B and C articles 510 and 520 is 3, and hubness of 1 for the D article 530 since the number of later links to the D article 530 is 1.

In the end, hubness of the particular user may be represented as average of hubnesses evaluated for these articles. That is, hubness of the particular user may be expressed by the following Equation 8.

Hubness=Average{3,2,2,1}=2 [Equation 8]

As hubness expressed by Equation 8 increases, the increasing hubness is applied at any later recommendations, and thus, an effect of the particular user on other users increases.

As can be seen from the above description, since a better article has the more number of relies or recommendations, a user has high hubness when preferential recommendations or replies for a good article are made. On the contrary, a bad article has less recommendations or replies. Accordingly, although senseless recommendations for the bad article are preferentially made, since there are little users who add recommendations or replies to the bad article, hubness of the bad article becomes lowered.

Accordingly, the link evaluation method of the present invention allows good articles to be evaluated reasonably. In other words, a good article with higher evaluation has higher hubness, resulting in high reliability of the good article.

FIG. 6 is a view illustrating an authority calculating method according to an embodiment of the present invention.

Referring to FIG. 6, as described above, in calculating authority according to the present invention, the more the linked upper nodes, the higher authority the lower node has, resulting in higher importance of the lower node.

For example, authority for a particular article 600 may be calculated by the number of links of replies linked to the article 600 (i.e., the number of recommendations). For example, assuming that an A reply 610 has three recommendations 650, a B reply 620 has three recommendations, a C reply 630 has one recommendation, and a D reply 640 has one recommendation, authority for the article 600 may be calculated as an average of number of recommendations to each of the replies.

Accordingly, authority for the article may be expressed by the following Equation 9.

Authority=Average{3,3,1,1}=2 [Equation 9]

When authority in Equation 9 increases, a degree of disclosure of the article may increase according to application of authority. In other words, since importance of the article may be determined depending on the number of recommendations or replies of users, if the article is an article with high authority calculated according to the present invention, the degree of disclosure of the article may be varied according to an order of authority.

As described above, when values of nodes are evaluated according to the link relation, by reflecting a link order of upper nodes on importance of a lower node, unlike the conventional link analysis methods, fast and precise evaluation of users for real time-increasing objects such as news becomes possible.

Moreover, when the above-described evaluation method is applied to web sites and the like, an editor function may be granted to users with high hubness and a pressman function may be granted to users with high authority.

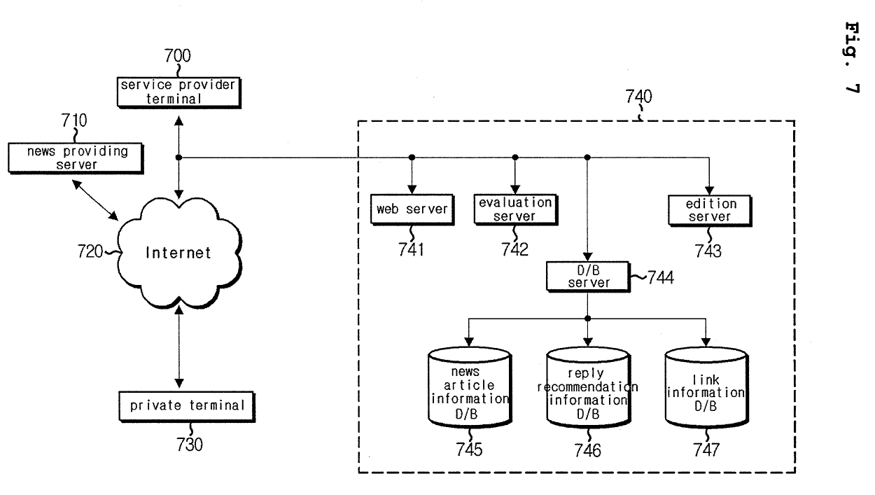

Hereinafter, a value analysis system based on evaluation on news articles in an Internet network that performs analysis on the new articles according to the above-described link analysis method of the present invention will be described with reference to FIGS. 7 to 10.

FIG. 7 is a view illustrating a structure of a value analysis system based on evaluation on news articles in an Internet network according to an embodiment of the present invention.

Referring to FIG. 7, a value analysis system of the present invention may include a service provider terminal 700, a news providing server 710, Internet 720, a private terminal 730, a value analysis server 740, etc.

When news article information is first provided from the news providing server 710 to a server of a service provider (for example, a service provider of a portal site), each evaluation subject reads the news article after accessing the value analysis server 740 of the service provider through the private terminal 730, and performs evaluation on the news article through replies or recommendations to the news article. Then, the value analysis server 740 calculates hubness and authority according to the above-described calculation method of the present invention, processes the calculated hubness and authority, and then provides new edition information, network information, etc., which are produced based on the processed hubness and authority and will be described later, to the evaluation subjects.

The value analysis server 740 constructed by the service provider, which may be a server including a kind of portal site server, may receive the news information from the news providing server 710 or may produce and store news information for itself. In addition, each of individual users who read the news information through Internet 720 transmits news evaluation information to the value analysis server 740 through his own private terminal 730. Then, the value analysis server 740 stores the news information and the news evaluation information of the individual users and performs value evaluation on evaluation subjects and objects of the news according to the evaluation method of the present invention.

As shown in FIG. 7, the news providing server 740 may include a web server 741, an evaluation server 742, an edition server 743, a database (D/B) server 744, etc.

The web server 741 serves to construct web pages and the like and provide news information to the individual terminal 730 through Internet 720. The evaluation server 742 calculates hubness and authority based on a result of evaluation of each individual user on the stored news information, and link relation information. Then, the edition server 743 processes hubness and authority of evaluation subjects and objects, which are calculated in the evaluation server 742, and provides new process and edition information (for example, a reconstructed news menu, a editor menu for each user, etc.) to the evaluation subjects.

The D/B server 744, which may include a news article information database 745, a reply recommendation information database 746, a link information database 747, etc., structuralizes and stores various kinds of information for service performance.

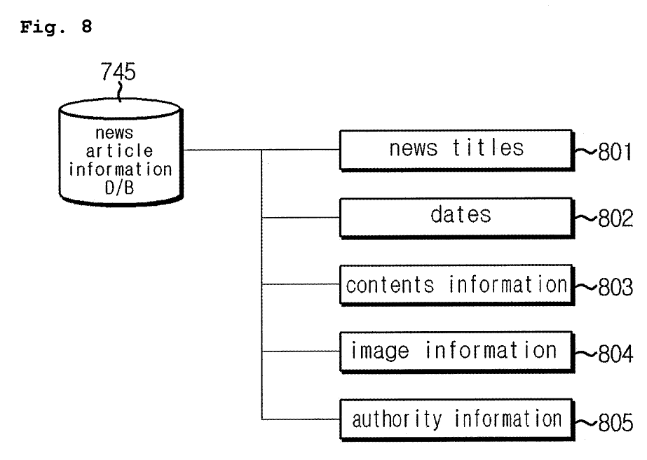

Hereinafter, data fields constituting the above-mentioned databases will be described with reference to FIGS. 8 to 10.

FIG. 8 is a view illustrating data fields of the news article information database 747 according to an embodiment of the present invention. Referring to FIG. 8, the news article information database 745 may include data fields of news titles 801, dates 802, contents information 803, image information 804, authority information 805, etc. These data fields, which are various kinds of information constituting news articles, may further include authority information on news article information, which is calculated in the evaluation server 742.

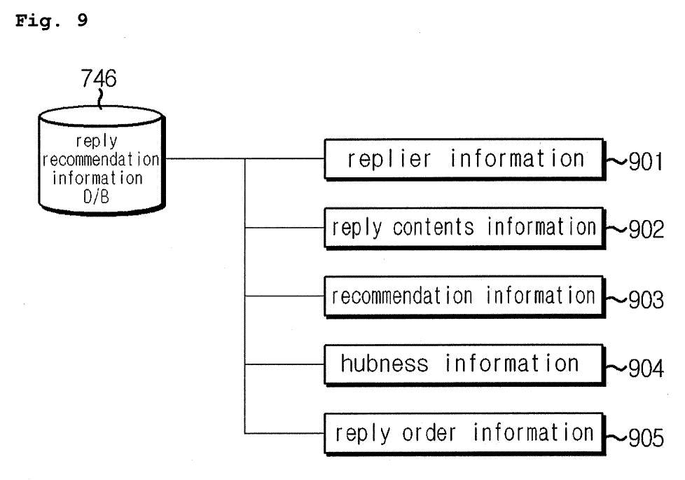

FIG. 9 is a view illustrating data fields of the reply recommendation information database 746 according to an embodiment of the present invention.

Referring to FIG. 9, the reply recommendation information database 746 may include data fields of replier information 901, reply contents information 902, recommendation information 903, hubness information 904, reply order information 905, etc. That is, the reply recommendation information database 746 may store evaluation information (for example, replies, recommendations and the like) of individual users for news articles, and may further include hubness information for the individual users, which is calculated in the evaluation server 742 according to the calculation method of the present invention, to be used to analyze a result of the evaluation. In addition, the included reply order information is information to be used to analyze the news information.

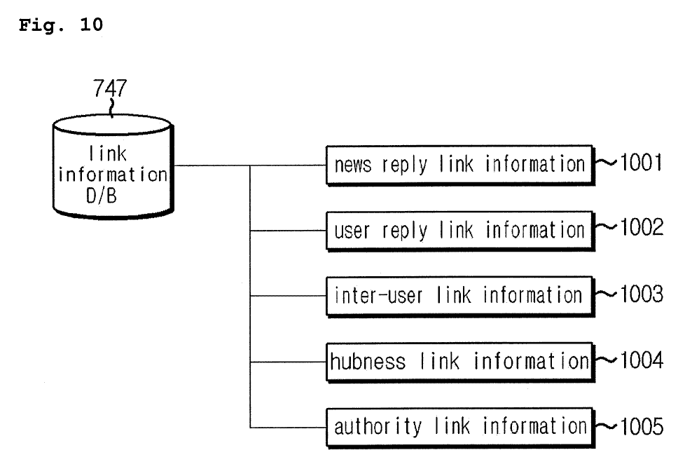

FIG. 10 is a view illustrating data fields of the link information database 747 according to an embodiment of the present invention.

Referring to FIG. 10, the link information database 747 may include data fields of news reply link information 1001, user reply link information 1002, inter-user link information 1003, authority link information 1004, hubness link information 1005, etc. That is, since the value analysis system of the present invention uses information on links between evaluation subjects and objects and the link order information in order to analyze the news article information, the link information database 747 may include various kinds of link information to be used to evaluate the news article information.

The news reply link information 1001 is information on links to replies linked to particular news articles, and the user reply link information 1002 is information on links to users for replies. In addition, the inter-user link information 1003 is information on a link order between users who registered replies to the same news or recommendation links to the registered replies. The authority link information 1004 and the hubness link information 1005 are link relation information required for calculation of authority and hubness.

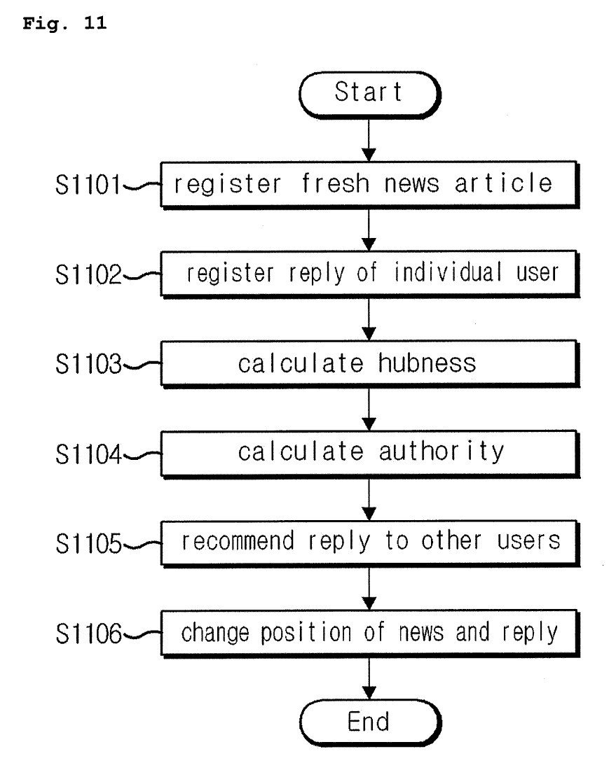

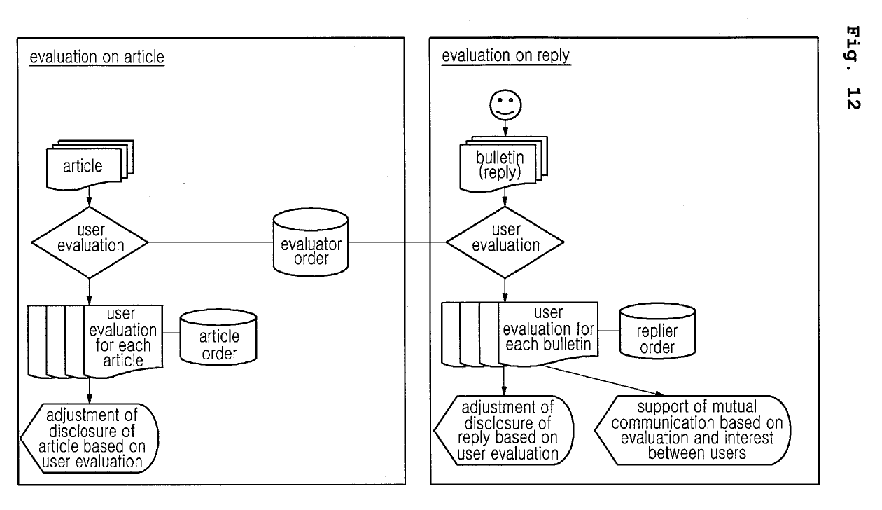

Hitherto, the value analysis system according to the embodiment of the present invention has been described. Hereafter, a value analysis procedure based on evaluation on news articles according to an embodiment of the present invention will be described with reference to FIGS. 11 and 12.

FIG. 11 is a flow chart illustrating a value analysis procedure based on evaluation on news articles in an Internet network according to an embodiment of the present invention.

Referring to FIG. 11, a news provider registers new news article information in various portal sites and the like (Step S1101). In this case, the news provider may be various broadcasting stations or press media, or sources of news in various portal sites. Then, the registered news article information is provided to the users in the form of a web page through the portal sites.

At this time, individual users may search and read the news articles through their own computer terminals and register replies to the news (Step S1102). Then, evaluation and analysis for the registered news articles and the registered replies are performed in real time according to the evaluation and analysis method of the present invention. Specifically, hubness and authority for the news article information and news article evaluators are calculated based on the registered news articles and the registered replies (Step S1103 and Step S1104). At this time, hubness and authority are calculated in consideration of various link connection orders.

In addition, other users may recommend a reply made by a particular user (Step S1105). At this time, hubness and authority for a replier to be recommended to make a reply or a recommender may be calculated. In the mean time, positions and so on of news and replies to the news may be reedited based on the calculated authority and hubness.

FIG. 12 is a flow chart illustrating an evaluation procedure for articles and replies according to an embodiment of the present invention.

Referring to FIG. 12, when the user evaluation on the news article information is made as illustrated in FIG. 11, registration order information on the user evaluation (that is, evaluator order) is stored for the calculation of hubness and authority. In addition, importance orders of articles are reorganized based on the user evaluation for each of the articles. In the end, the degree of disclosure of each article is adjusted in real time according to an evaluation level for each article.

In the mean time, user evaluation on bulletins (for example, replies) registered in a particular news article may be made. When the user evaluation on bulletins is made, registration order information on the bulletin evaluation (that is, evaluator order) is stored for the calculation of hubness and authority, as in the evaluation on the news article information. At this time, the degree of disclosure of each of the bulletins (for example, replies) may be adjusted in real time according to the bulletin evaluation, like the news article information.

In addition, a new service associated with mutual communication based on link information on evaluation and interest between a user who registers a bulletin and a user who evaluates the bulletin.

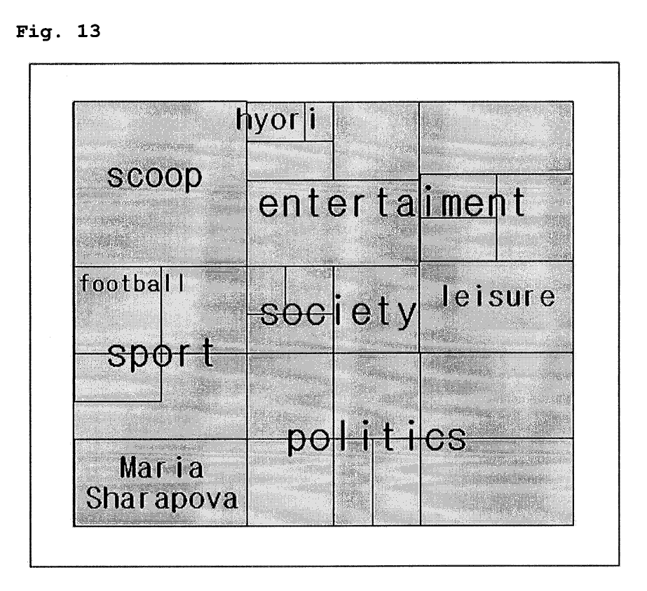

Hereinafter, examples of various services that can be provided as an evaluation result calculated according to the information evaluation and analysis method of the present invention will be described with reference to FIGS. 13 to 17.

FIG. 13 is a view illustrating a method of providing a comprehensive viewpoint for each news importance according to an embodiment of the present invention. Referring to FIG. 13, importance of news articles is defined based on a scale of formation of public opinions among users rather than news editors, in order to support prospect of flow of general public opinions.

In other words, by determining importance of news articles according to orders of authority or hubness for each category based on the above-described evaluation on the news articles, a comprehensive viewpoint for each news importance can be more efficiently provided.

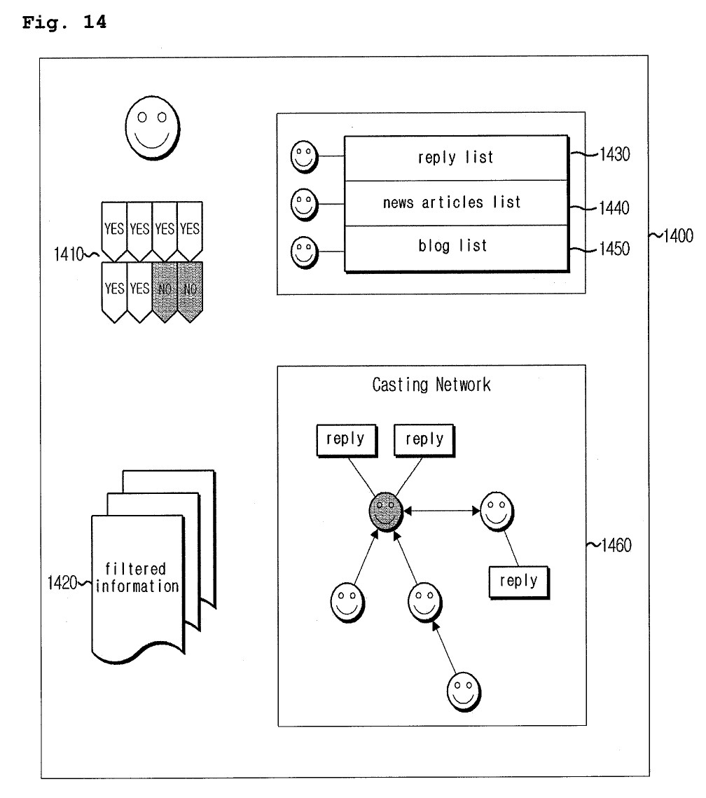

FIG. 14 is a view illustrating an individual user interface related to a news network according to an embodiment of the present invention. Referring to FIG. 14, a unique user interface (UI) 1400 for each individual user can be provided as one of various kinds of link information produced according to the present invention, as illustrated in FIGS. 11 and 12.

In this case, agreement (YES) or disagreement (NO) 1410 about a bulletin registered by the user may be displayed on the user interface 1400, and information 1420 filtered based on the user evaluation may be provided. In addition, lists or contents of replies 1430, news articles 1440, blogs 1450 and so on, which are registered by the user, may be provided clearly at a glance. In addition, news communication among users may be implemented by providing information on link relation among other users, who register replies to the bulletin registered by the user or recommend the bulletin, in the form of a casting network 1460.

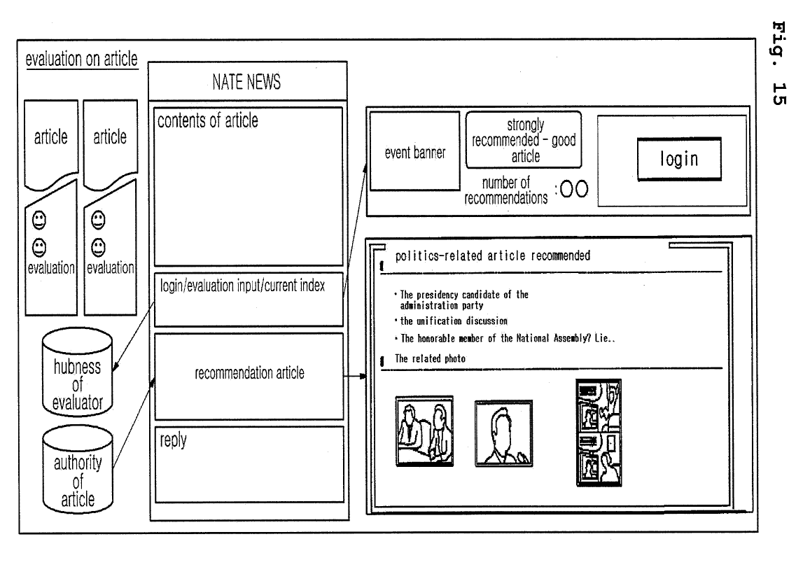

FIG. 15 is a view illustrating an evaluation method for articles according to an embodiment of the present invention. Referring to FIG. 15, users make evaluation on a particular news article according to the evaluation method of the present invention. At this time, as described above, hubness of the evaluators or authority of the news article according to the evaluation is calculated in real time.

In this case, it is preferable that the evaluators make the evaluation after logging in a site in which the news article is registered, and existing hubness and current hubness are reflected to calculate new hubness of the evaluators according to the evaluation. At this time, an event banner advertisement for inducement to participation of users and a log-in interface may be provided for effective evaluation of the evaluators.

In addition, it is possible to provide a recommendation article (that is, another article recommended by a user who recommends an evaluated article or an article frequently recommended in a current section) in the form of a link according to authority of the evaluated article.

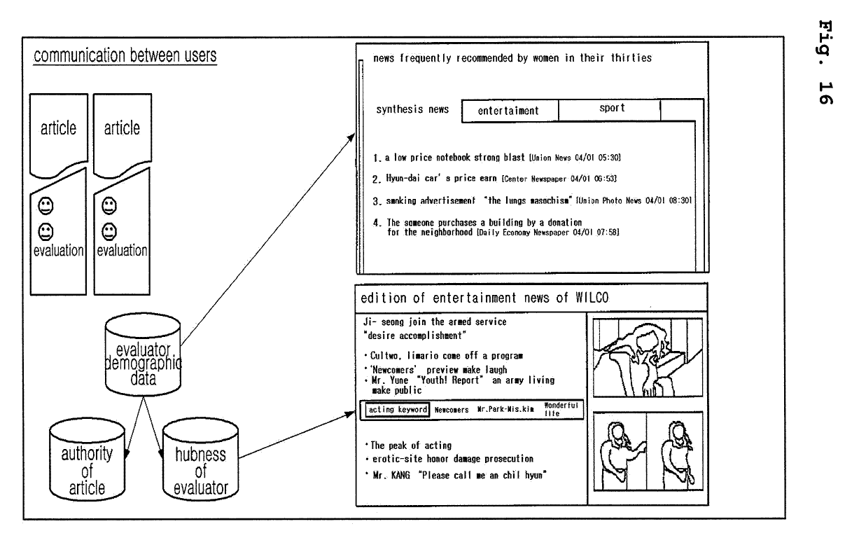

FIG. 16 is a view illustrating an inter-user communication method according to an embodiment of the present invention. Referring to FIG. 16, statistical data may be calculated and provided using a result of evaluation on a particular article (that is, authority of an article evaluated by an evaluator or hubness of the evaluator).

For example, new process information such as ‘news frequently recommended by women in their thirties’ may be provided using a result of evaluation by women in their thirties among evaluators. In addition, news edited for a particular category of an evaluator with high hubness may be provided.

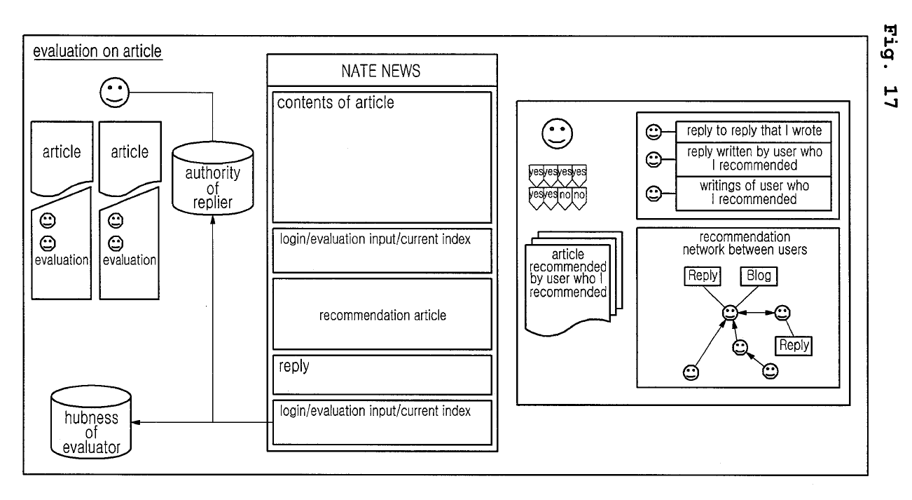

FIG. 17 is a view illustrating an evaluation method for replies to articles according to an embodiment of the present invention. Although it has been illustrated in FIG. 15 that various servicing methods are proposed based on authority of news and hubness of evaluators who evaluate the news, FIG. 17 shows that authority of users who register replies to the news and hubness of the users who evaluate the replies may be calculated through evaluation on the users who register the replies according to the same method. In addition, the same service as in the news evaluation may be provided using the calculated evaluation information.

According to the above-described real-time news evaluation communication method with high efficiency, active users may play a leading role in forming public opinions by expressing their opinions on their own blogs or news, while other users may play a role as searchers who discover and publish fresh news or blog writings rather than express their opinions. On the other hand, passive users may construct a network to filter and cast news in their place by showing their own basic tastes through expression of opinions such as agreement/disagreement.

### INDUSTRIAL AVAILABILITY

According to the present invention, it is possible to provide an efficient and dynamic evaluation method by granting a high evaluation index to an evaluation subject or object according to replies to Internet contents, a recommendation order to Internet contents, or a recommendation order to the replies. In addition, it is possible to provide a reedition function based on importance of contents and an individual editor function based on analysis on an evaluation index acquired by an evaluation subject, using a result of evaluation according to the evaluation method. Further, it is possible to provide new value information processed in a new network established based on a link relation among evaluation subjects and objects for contents evaluation.

While the present invention has been particularly shown and described with reference to exemplary embodiments thereof, it will be understood by those skilled in the art that various changes in form and details may be made therein without departing from the spirit and scope of the present invention as defined by the appended claims and equivalents thereof.

1. A system for evaluating contents in an Internet network, comprising:
a user terminal for accessing contents information registered in real time and provided through a web page and performing evaluation on the contents information; and
a value analysis server for calculating hubness of each evaluator according to an evaluation order of the contents information and calculating authority of the evaluated contents information based on hubness of each evaluator.

2. The system according to claim 1, wherein the contents information is news articles.

3. The system according to claim 1, wherein the contents information is replies to news articles.

4. The system according to claim 2, wherein the evaluation information is reply information.

5. The system according to claim 2, wherein the evaluation information is recommendation information.

6. The system according to claim 1, wherein disclosure of the contents information is adjusted according to authority calculated for the contents.

7. The system according to claim 1, wherein the system provides an editor menu for each user, which is reconstructed according to hubness calculated for each evaluator.

8. The system according to claim 1, wherein the value analysis server comprises:
a news article information database including various kinds of information constituting the contents information;
a reply recommendation information database including evaluation information on the evaluators; and
a link information database including various kinds of link information for the contents information evaluation.

9. A method for evaluating contents in an Internet network, comprising the steps of:
by a contents provider, registering new contents information as a web page in a web site;
providing the registered contents information to each user in the form of a web page through the web site;
by a user, searching and reading the contents through a computer terminal and registering evaluation information on the contents in the web site; and
calculating hubness of each evaluator according to an evaluation order of the registered evaluation information and calculating authority of the evaluated contents based on hubness of each evaluator.

10. The method according to claim 9, wherein the contents information is news articles.

11. The method according to claim 9, wherein the contents information is replies to news articles.

12. The method according to claim 10, wherein the evaluation information is reply information.

13. The method according to claim 10, wherein the evaluation information is recommendation information.

14. The method according to claim 9, wherein disclosure of the contents information is adjusted according to authority calculated for the contents.

15. The method according to claim 9, further comprising the step of providing an editor menu for each user, which is reconstructed according to hubness calculated for each evaluator.

16. A computer readable medium containing a program for performing the method according to claim 9.

17. The system according to claim 3, wherein the evaluation information is reply information.

18. The system according to claim 3, wherein the evaluation information is recommendation information.

19. The method according to claim 11, wherein the evaluation information is reply information.

20. The method according to claim 11, wherein the evaluation information is recommendation information.
